(19) United States
(12) Patent Application Publication
(10) Pub. No.: US 2026/0168879 A1
(43) Pub. Date: Jun. 18, 2026

(54) CENTER OF GRAVITY MEASUREMENT FOR LAUNCH VEHICLES

(71) Applicant: BLUE ORIGIN, LLC, KENT, WA (US)

(72) Inventors: Jason Mark Patterson, Rockledge, FL (US); Dustin P. Roark, Satellite Beach, FL (US); Brian Hrywnak, Kenmore, WA (US)

(21) Appl. No.: 18/980,996

(22) Filed: Dec. 13, 2024

(51) Int. Cl. G01M 1/12; B64G 5/00

(52) U.S. Cl. CPC G01M 1/125; B64G 5/00

(57) ABSTRACT

Systems and methods disclosed herein are for determining a pre-launch center of gravity (CG) of at least one component of a launch vehicle which may be subject to shifts or changes in CG after launch. The systems and methods may include a tool with an adapter base which may be configured to attach to the component and may include counterweights or segmented weights. The tool may be hoisted with the component for first CG measurements and may be hoisted independently of the component for second CG measurements. The first and second CG measurements may be used to determine the CG of the component of the launch vehicle.

### TECHNICAL FIELD

The present disclosure is generally related to center of gravity (CG) measurement systems and methods for a launch vehicle and its associated components.

### BACKGROUND

Launch vehicles include various components, including payload modules for cargo or crew. Such cargo or crew may include or introduce different instabilities and shifts in a CG for the launch vehicle and its associated components.

### SUMMARY

In some aspects, the disclosure herein may include systems used for a CG measurement. At least one of the systems may include an adapter base. The adapter base may include a first side and a second side. The first side may allow association between the adapter base and at least one component of a launch vehicle. The system may include a tool which may be associated with the second side of the adapter base. The tool may be associated with one or more counterweights. The tool may be adapted to be hoisted with the component for first CG measurements. The tool may be adapted to be hoisted independently of the component for second CG measurements. A CG measurement for the component may be based in part on a difference between the first CG measurements and the second CG measurements.

In other non-limiting aspects, the disclosure herein includes a tool to be associated with at least one component of a launch vehicle. The tool may be adapted to include one or more counterweights or segmented weights thereon. The tool may also be adapted to be hoisted or weighed in a stabilized position with at least one component and with the one or more counterweights or segmented weights attached thereon. The stabilized position may be to allow at least one operation to be performed on at least one component of the launch vehicle.

In further non-limiting aspects, the disclosure herein includes a method for a CG measurement for at least one component of a launch vehicle. The method may include associating an adapter base with the at least one component on a first side of the adapter base. The method may include associating a tool with a second side of the adapter base. The method may include allowing one or more counterweights to be associated with the tool. Another step in the method may be to allow the tool to be hoisted with the at least one component for the first CG measurements and independent of the at least one component for the second CG measurements. The method may include a step to determine the CG measurement for the at least one component based in part on a difference between the first CG measurements and the second CG measurements.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates aspects of a system used for a CG measurement for components of a launch vehicle, in accordance with at least one non-limiting aspect of the present disclosure;

FIG. 2A illustrates a segment of a tool for a CG measurement for one component of a launch vehicle, in accordance with a further non-limiting aspect of the present disclosure;

FIG. 2B and FIG. 2C illustrate different views of an adapter base used for a CG measurement, in accordance with a further non-limiting aspect of the present disclosure;

FIG. 2D illustrates counterweights used for a CG measurement, in accordance with a further non-limiting aspect of the present disclosure;

FIG. 3A illustrates aspects of hoisting a tool having multiple segments for a CG measurement, in accordance with a further non-limiting aspect of the present disclosure;

FIG. 3B illustrates further aspects of hoisting to reach a stabilized position for a tool used for a CG measurement, in accordance with a further non-limiting aspect of the present disclosure;

FIG. 3C illustrates a stabilized position for a CG measurement, in accordance with a further non-limiting aspect of the present disclosure;

FIGS. 3D-3F illustrate aspects used for a three-axis CG or measurement of a static load, in accordance with a further non-limiting aspect of the present disclosure;

FIG. 4 illustrates an example space mission having components capable of CG changes and which benefit from CG measurement, a three-axis CG, or measurement of a static load, in accordance with a further non-limiting aspect of the present disclosure;

FIG. 5 illustrates a method associated with a system used for a CG measurement, in accordance with a further non-limiting aspect of the present disclosure; and

FIG. 6 illustrates a further method associated with a system used for a CG measurement, in accordance with a further non-limiting aspect of the present disclosure.

### DETAILED DESCRIPTION

Launch vehicles have a combined center of gravity (CG). One or more components of the launch vehicle may contribute to the combined CG. The CG for the launch vehicle and/or the components may shift or change during flight. The combined mass CG and the shifts in CG may be predetermined by taking into account the CG of each of the components in different pre-flight activities performed prior to launch (or pre-launch). For example, a payload adapter, such as a fixed adapter (FA), may be one component in a launch vehicle which may be a basis for determination of an overall launch vehicle CG. The FA may be subject to changes in orientation with respect to X-Y-Z axes during flight. Other components of the launch vehicle may also be subject to CG changes and may be individually subject to CG measurements. The CG measurements obtained pre-launch for one or more of the FA or the components may be used to develop trajectories, guidance-navigation-control (GNC) inputs and/or outputs, and sequential changes in CG as a launch vehicle proceeds through a space mission. The pre-launch trajectories, guidance-navigation-control inputs and/or outputs, and sequential changes in CG may ensure controllability of the launch vehicle during flight. A tool, system, and/or method as disclosed herein can be used to perform the CG measurements as part of pre-flight activities for components of the launch vehicle.

Another component of the launch vehicle which may be subject to CG measurements may be a payload module. The payload module may include the FA at a base of the payload module. The payload module may be configured to be removably attached to a propellant module via the FA. The combination of the payload module and the propellant module may be part of a second stage or an upper stage of a launch vehicle. There can be multiple configurations (such as different sizes or capacities) of FAs used to accommodate different sizes or capacities of payload modules in the upper stage.

A launch vehicle, after launch, may be subject to trajectory changes upon ascent and its CG may shift. Further, there may be components of the launch vehicle which are subject to deployment along their own paths or trajectories. These components may be also subject to shifts in their respective CGs. A system or a method for measurement of CG, which is performed prior to launch, may include a tool or use of a tool having one or more segments. The tool can be configured for a CG measurement for at least one component of the launch vehicle. For example, the FA may be a component subject to CG measurement. Similarly, a payload or a payload adapter may be another component subject to CG measurement. In addition, it is also possible to combine components for CG measurements. For instance, the payload module with the payload and/or with the FA may altogether form a component which is subject to CG measurement.

A tool for a CG measurement may also include an adapter base. The adapter base may be a physical feature which can be associated, on its first side, with the component of a launch vehicle. The adapter base may be associated with the tool on its second side, which is opposite its first side. The adapter base may be sandwiched between the component of the launch vehicle and the tool. The adapter base may be one of different adapter bases to allow different components to be associated with a same tool by, in part, changing to a suitable one of different adapter bases. The different adapter bases may have different shapes or dimensions and may also have different couplings to be used with different components of the launch vehicle. An adapter base may also be provided in place of a beanie cap of an FA for operations performed on the FA or the launch vehicle, independent of the CG measurements.

A tool for a CG measurement may be subject to hoisting using a crane or other hoist. The crane or other hoist may be associated with load cell scales for measurement of weights associated with the tool. For instance, for the CG measurement of a component, the tool may be hoisted with the component attached and with counterweights attached for the first CG measurements once the tool is in a stabilized horizontal position. The tool is also adapted to be hoisted independently of any component, but with the counterweights attached for the second CG measurements. The CG measurement for the component may be based in part on a difference between the first CG measurements and the second CG measurements.

A tool for CG measurement may be hoisted from a stabilized vertical orientation, rotated to the stabilized horizontal position, and subject to weight or load cell measurements. In one example, the stabilized horizontal position may be at or about a 90-degree rotation from a stabilized vertical orientation of the tool. A vertical orientation may be in line with a launch axis for a launch vehicle and may be substantially perpendicular to a terrestrial surface. A stabilized orientation, whether vertical or horizontal, may be when there is no unintended oscillation or movement in the tool or when there is unintended oscillation or movement which may be within a predetermined threshold in the tool or a system having the tool, generally.

One or more counterweights may be used to counter weights associated with the component on the tool. The counterweights may be positioned on the tool, at an opposite end of the tool, relative to the component. Separately, segmented weights may be one or more weights which may be attached on one or more sides of the tool. The segmented weights may be used for simulating changes to a CG or for static loads to be associated with the component. The use of one or more of the counterweights or the segmented weights also allows for manual adjustment of the CG of a component for testing purposes. In one instance, any adjustment made may be possible by the counterweights and/or the segmented weights being removably installed using a bolt-on and/or quick release features.

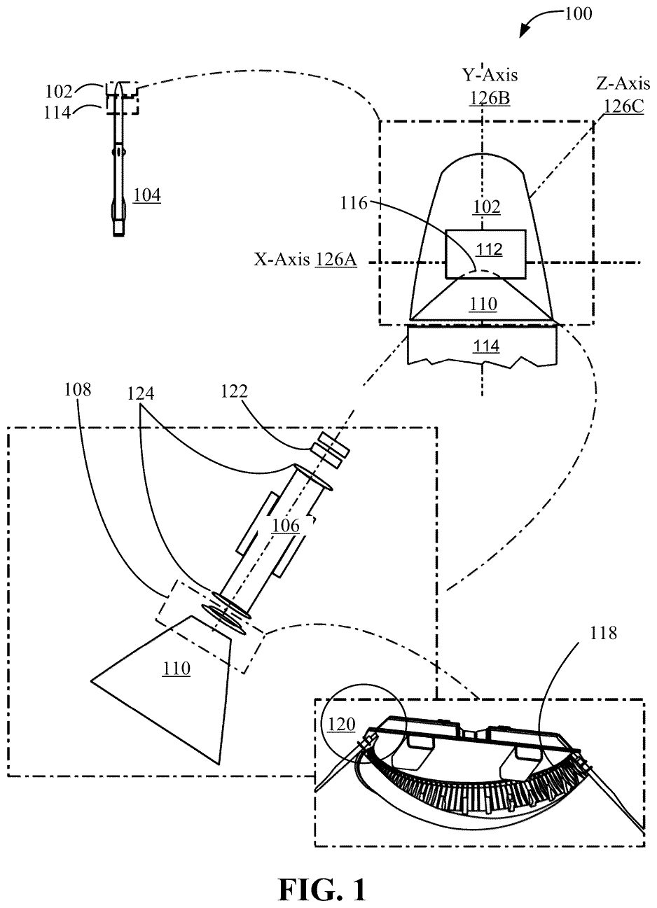

FIG. 1 illustrates aspects 100 of a system used for a CG measurement for one component of a launch vehicle, in accordance with one non-limiting aspect of the present disclosure. A component of the launch vehicle 104 may be subject to precise handling and positioning for CG measurement using, in part, a tool 106 and supported, in part, by an adapter base 108. The one component may be an FA 110, the payload module 102, the payload 112, an upper stage propulsion module 114, or any other component of the launch vehicle 104 which may benefit from CG measurements. The description of the tool used to measure a CG of an FA 110, as one component of the launch vehicle, is only an example which is applicable to the other components for respective CG measurements, unless stated otherwise.

CG measurements using the tool 106 herein can be performed without any other mechanical connections or supports on the component of the launch vehicle 104. For instance, there may be no further connection, other than the adapter base 108 connected to the component of the launch vehicle 104, to achieve a CG measurement of the component in the X-axis. The CG measurements in the X-axis, a three-axis CG, and a measurement of a static load may all be performable using the tool 106. All such measurements may apply to any component of the launch vehicle, although the FA 110 is illustrated as an example.

The FA 110 may be a structural and electrical interface between a payload 112 of the payload module 102 and the upper stage propulsion module 114 of the launch vehicle 104. In one example, once the launch vehicle 104 achieves a specified orbit, the upper stage propulsion module 114 may transmit a command to release the payload 112 through the interface of the FA 110. The FA 110 may be provided in a standard or a high-capacity configuration to suit the requirements of the payload module 102, the payload 112, or the upper stage propulsion module 114 of the launch vehicle 104.

The FA 110 may be designed to support the structural requirements of a space mission. The FA 110 may also support therein a further payload or various mounted instruments, wire harnesses, access panels, frames, secondary structures, and mounting brackets. A top of the FA 110 may be covered by a beanie cap 116 prior to use in the launch vehicle 104. A tool 106 herein may offer an alternative to the beanie cap 116 for at least some operations involving the FA 110. The top of the FA 110, when opened or exposed, may include a payload interface ring 118, which may be referred to as an interface between the FA 110 and a separation system of a payload 112. The payload interface ring 118 may include mechanical fasteners or other fixtures. The payload interface ring 118 may be used for the association of the adapter base 108 to the component.

FIG. 1 also illustrates that an adapter base 108, used with a tool 106, may include coupling features 120. The coupling features 120 may include bolt holes and associated bolts or other fasteners to removably associate the adapter base 108 to the FA 110 of the payload module 102. The tool 106 herein may be designed as an economical, easily storable, and long term indoor or outdoor mechanical assembly, which is also easy to assemble, disassemble, and maintain. Further, the tool 106 may be used in a vertical orientation to install or remove an adapter base 108 from the payload module 102.

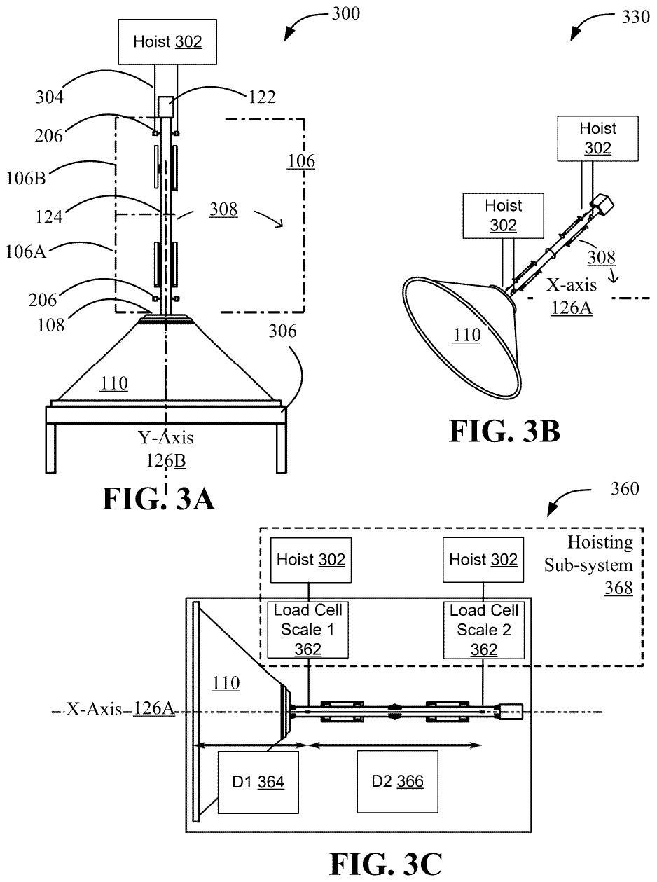

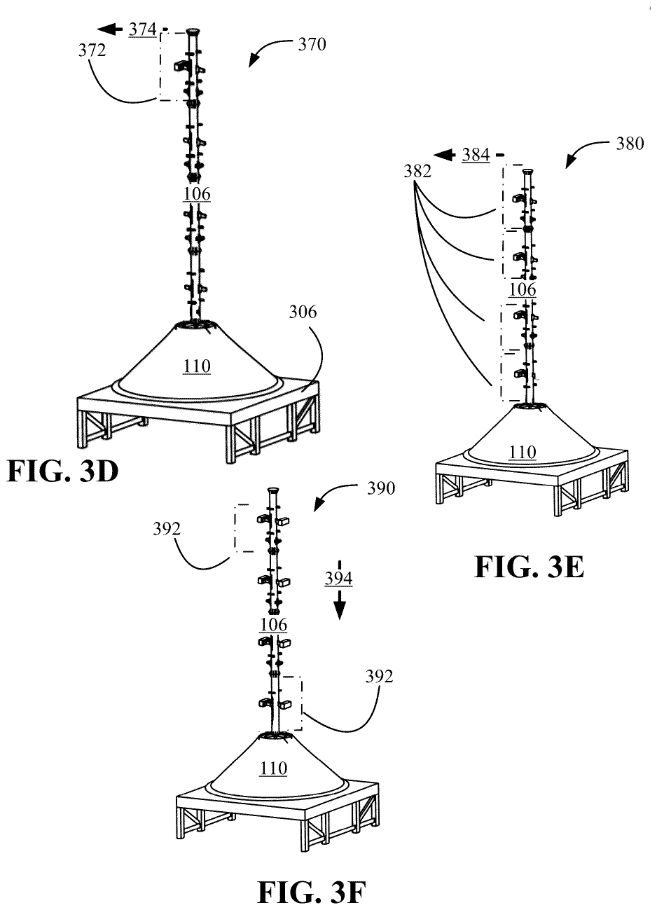

One of the aspects 100 of a system used for a CG measurement in FIG. 1 may include the adapter base 108 in association with at least one component on a first side (underside) of the adapter base 108. A tool 106, on its one end, may be associated with a second side (top side) of the adapter base 108, as part of the system. The tool 106, on its other end, may be adapted for association with one or more counterweights 122. The tool 106 may be adapted to be hoisted, as discussed further in connection with FIGS. 3A-3C. For instance, the tool 106 may be hoisted, in a first step, with the component attached thereon, for first CG measurements. The tool 106 may be hoisted in a separate or second step, independent of the component, for second CG measurements. For example, the tool 106 without the component, but with the same ones of the counterweights 122 attached, may be hoisted for the second CG measurements. The CG measurement for the component may be based in part on a difference between the first CG measurements and the second CG measurements.

The tool 106 may include multiple end features 124 to allow the tool 106 to be reversibly used with the component. For instance, the tool 106 may include symmetrical features to be reversibly used with the component for CG measurements. The end features 124 also allow the tool 106 to include at least two segments 106A, 106B (as illustrated in at least FIG. 3A), which can be individually associated together at respective ones of the end features 124. The end features 124 can allow the tool 106 to be reversibly used with the adapter base 108. The adapter base 108 may be removably coupled to the component and may allow measurements of weights associated with the component or the tool 106. These weights may be in support of a determination of a CG measurement associated with one or more of the one component or the tool 106.

The weight and the CG measurements may be required to determine an as-built weight and a CG in 3-axis for one component. For instance, the first and the second CG measurements for a component may be performed in the horizontal position (X-plane or axis 126A) while hoisted, as detailed further in connection with at least FIGS. 3A-3C herein. The component may also be subject to CG measurements in YZ-plane represented by different ones of the axes 126B, 126C. The CG measurements in the YZ-plane may be performed while the tool with the component attached is standing in a vertical position or along a vertical axis 126B, which is perpendicular to a terrestrial surface. For instance, the CG measurements for the YZ-plane represented by different ones of the axes 126B, 126C may be performed on a floor supported by 3 or 4 flat scales.

In one example, the adapter base 108 can be associated with the component on a first side of the adapter base 108 and the tool 106 can be associated with a second side of the adapter base 108. Further, the tool 106 may be associated with one or more counterweights 122, which may be on an opposite side, relative to the one component. The system having the adapter base 108, the counterweights 122, and the tool 106 may be hoisted with the component for the first CG measurements and may be hoisted independently of the one component for the second CG measurements. The hoisting may be performed using at least two connecting points (discussed in at least FIG. 3A) on the tool. The CG measurements may include repeated CG measurements to be averaged for consistency and/or verification of a CG measurement for a component of the launch vehicle.

In one example, a hoisting sub-system may include load cell scales (in FIG. 3A) at the two connecting points. The load cell scales may be used to measure aft and forward weights associated with the component and the counterweights 122 present on the tool 106. The load cell scales may be used to perform the same aft and forward weights measurement without the component being present on the tool 106 (also referred to herein as weights measured independent of the component of the launch vehicle). The aft and forward measured weights in each case (with and without the component) can be used to determine the first CG measurements and the second CG measurements. In one example, the aft and forward measured weights, along with a total weight and distances to at least one of the two connecting points (such as distances from each end of the tool 106 to an aft connecting point which may be closest to a side associated with the component), can be used to determine a CG ratio or CG for the tool in each case. The tool 106 may be maintained substantially parallel to a horizontal axis (stabilized horizontal position), which is along the terrestrial surface during the CG measurements. The CG measurement for the one component may be the difference in the first CG measurements and the second CG measurements, in one example.

As such, it is possible to address a difficulty in measuring an X-axis CG of a component when the component is an encapsulated payload or includes an encapsulated load. An encapsulated load may represent an inherently unstable and difficult-to-measure black-box or other unknown loads. Further, the difficulty in performing measurements may also be an issue when the component of the launch vehicle 104 is in a horizontal orientation, which may be in line with a terrestrial surface. The tool 106 provides, in part, a counter weighed lever arm with the counterweights attached. The component can be supported in a stabilized position (or orientation, as detailed in at least FIG. 3C) by being hoisted. In one example, the stabilized position is such that the tool 106 has its X-axis parallel to a terrestrial or ground surface. In such a position, weights obtained using load cell scales (also in FIG. 3C) may be used to determine a full three-axis (3-axis) CG.

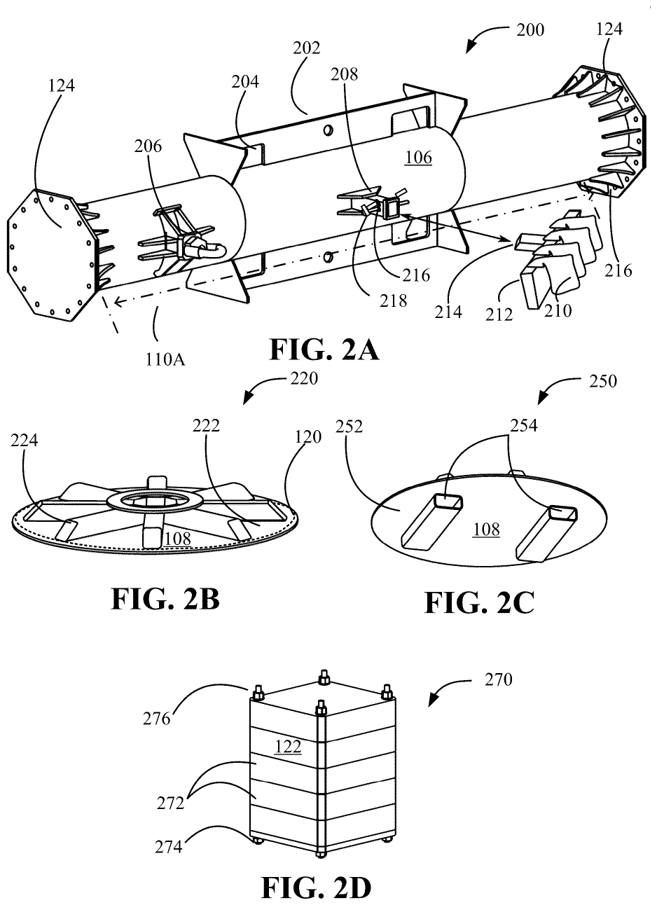

FIG. 2A illustrates a segment 200 of a tool 106 used for a CG measurement, in accordance with a further non-limiting aspect of the present disclosure. The segment 200 may include respective ones of the end features 124, one or more connecting points 206 (illustrated on one side of the tool 106 but that may be on opposing sides), one or more of the tow hitches 208 (also illustrated on one side of the tool 106 but that may be on opposite sides), and structural spines 202 with forklift-holds 204.

The one or more connecting points 206 may be used to hoist the tool 106 for the CG measurements described herein with respect to at least X-axis CG measurements for a component. The end features 124 may allow the tool 106 to include at least two segments 106A, 106B (as illustrated in at least FIG. 3A), which can be individually associated together at respective ones of the end features 124. At least one end feature of the provided end features 124 may allow the tool 106 to be reversibly used with the adapter base 108 by coupling features 120, such as the bolt holes and associated bolts or other fasteners. At least one other end feature of the provided end features 124 can allow the tool 106 to be attached to counterweights 122, where the counterweights 122 may be oppositely located, relative to the adapter base 108.

One or more tow hitches 208 may be used for adding segmented weights 210 to the tool 106. The addition of the segmented weights 210 to the one component may allow the one component to be subject to CG measurements in YZ-plane represented by different ones of the axes 126B, 126C, while standing in a vertical position or along a vertical axis 126B, which is perpendicular to a terrestrial surface. For instance, the segmented weights 210 may be associated with the one or more tow hitches 208 via a bracket 212 and a matching hitch 214 to fit into the one or more tow hitches 208. There may be multiple segmented weights per bracket 212 (for a total weight on each of the one or more tow hitches 208).

There may be four of the connecting points 206 on opposite sides of each segment 106A; 106B. The segments 106A, 106B may be clocked in any orientation relative to each other and to the adapter base 108. A bracket 212 may be of a predetermined weight (such as, in the range of 20-40 lbs.). The one or more tow hitches 208 may be welded-on and may be part of a series of tow hitches, which are about 2 per segment on the tool 106. There may be brackets 212 to connect to the one or more tow hitches 208. Further, the counterweights 122 may be rigged to integrated handles, flown up to the bracket 212, and may be clicked or connected into place. A crane or other hoist which may be used to hoist the tool may also be used to grab and place the counterweights 122. Once installed, the counterweights 122 may be secured by an integrated lock bar and cotter pin for safety purposes.

FIG. 2B and FIG. 2C illustrate different views 220, 250 of an adapter base 108 used for a CG measurement, in accordance with a further non-limiting aspect of the present disclosure. The adapter base 108 may include a top side 222 and a bottom side 252. The adapter base 108 may include structural members 224 and may include lift features 254 for a forklift to lift the adapter base 108. The adapter base 108 may include coupling features 120, such as the bolt holes and associated bolts or other fasteners to removably associate to an FA 110 or any component of a launch vehicle 104.

FIG. 2D illustrates aspects 270 of one or more counterweights 122 used for a CG measurement, in accordance with a further non-limiting aspect of the present disclosure. The one or more counterweights 122 may include counterweight segments 272, which may be associated together by fasteners 274, 276. A crane or other hoist may be used to hoist and place the counterweight segments 272 as required to create the illustrated stack of counterweights 122. Then, a crane may be used to hoist and install one or more counterweights 122 with the tool 106. Once installed, the counterweights 122 may be secured with the tool 106 by an integrated lock bar and cotter pin for safety purposes. In one example, the counterweight segments 272 may have one or more holes (such as bolt holes or through holes) through its centers to support stacking of the counterweights 122 and to support securing of the counterweights 122 with the tool 106 using the lock bar and cotter pin which may be through provided holes.

FIG. 3A illustrates aspects 300 of hoisting a tool 106 having multiple segments 106A, 106B for a CG measurement, in accordance with a further non-limiting aspect of the present disclosure. As illustrated, a hoist 302 (or hoisting feature) may be associated with the connecting points 206, using cables or other features 304, in a vertical position (along the Y-axis or vertical axis 126B) for the tool 106. The tool 106 may have the counterweights 122 and at least one component at its adapter base 108. The vertical position may be over a frame or a stand 306. The tool 106 is illustrated with two segments 106A, 106B, which are removably fastened together at respective ones of the end features 124 before the counterweights 122 and the association to the component are performed. The hoist 302 may be moved to cause the tool 106 to break-over, in the direction 308 illustrated, to an X-axis or horizontal axis 126A, which may be a horizontal position.

FIG. 3B illustrates further aspects 330 of hoisting to reach a stabilized position for a tool used for a CG measurement, in accordance with a further non-limiting aspect of the present disclosure. The break-over in the direction 308 illustrated may continue from the frame or stand 306, so that a system with the tool 106 is suspended in air on at least one side of the component. The tool 106 may not be in a stabilized position. The tool 106 may have its longest dimension (relative to its remaining dimensions) between the vertical position of the Y-axis or vertical axis 126B and the horizontal position of the X-axis or horizontal axis 126A. Subsequently, a horizontal position, representing the stabilized position, which may be intended for the tool 106, may be reached.

FIG. 3C illustrates a stabilized position 360 for a CG measurement, in accordance with a further non-limiting aspect of the present disclosure. The stabilized position 360 may be with the tool 106 having its longest dimension aligned along the X-axis or horizontal axis 126A. The two hoists 302 associated with the tool 106 may be part of a hoisting sub-system and may include individual load cell scales 1, 2 362 to measure weights associated with the component and, separately, with respect to the tool 106. The measured weights can be used to determine the first CG measurements and the second CG measurements. For instance, the measured weights may be used with illustrated ones of the distances D1 364, D2 366 to determine the first CG measurement with the component. The hoisting may be repeated without (or independent of) the component but with the same ones of the distances D1 364 and D2 366 measures for the second CG measurement. A difference of the first and the second CG measurements may be used to provide the CG measurement of the component.

The at least two of the hoists 302 may be associated with a hoisting sub-system 368 which may include a crane and may include the individual load cell scales 362 to measure the weights associated with the one component and with the tool 106. The measurements may be performed in support of a determination of a CG measurement associated with one or more of the components or the tool 106. The adapter base 108 and the tool 106 may be associated with the component and with the counterweights 122 in a vertical axis 126B, which is perpendicular to a terrestrial surface. The adapter base 108, the tool 106, and the component, along with the counterweights 122, may be rotated, in part, by being hoisted. The hoisting may be performed until at least the tool 106 and the one component clear the frame or stand 306 and until the tool 106 is substantially parallel to a horizontal axis 126A, which is along the terrestrial surface. Then, the first CG measurement and the second CG measurement may be determined based in part on the horizontal position representing the stabilized position being reached.

FIGS. 3D-3F illustrate aspects 370, 380, 390 for a 3-axis CG or measurement of a static load, in accordance with a further non-limiting aspect of the present disclosure. The aspects 370-390 illustrate that the segmented weights 210 may be used to allow, force, or simulate 374, 384, in part, a 3-axis CG to a known location (or set of locations) defined by mass properties of a system of a tool 106 and having the component (such as an FA 110) associated with the tool 106. The segmented weights 210 may also allow static load 394 for the component. A system having the tool 106 may not include the counterweights 122. The mass properties predicted using the aspects 370, 380, 390 herein can be verified by use of the YZ-axis scales provided with or associated with the frame or stand 306. The YZ-axis scales represent a lateral CG measurement, as against the X-axis hoist in FIG. 3C, which provides an axial CG measurement. The mass properties may include, other than the 3-axis CG, weight, and a 3-axis moment of inertia.

Further, in the YZ-axis, at least 3 flat scales may be evenly spaced on a terrestrial surface to support at least three legs of the frame or stand 306. Segmented weights 210 may be provided using one or more tow hitches 208. In at least one example, the segmented weights 210 may be used only in the vertical position of the tool 106 for static load measurement. The segmented weights 210 may not be provided for the horizontal position of the tool 106 and may not be used in the axial CG measurement. The counterweights 122, which may be used in the axial CG measurement, may be installed on the top of the tool 106 in the vertical position and during the lateral CG measurement but may not serve any purpose to the lateral CG measurement.

In one example, the segmented weights 210 may be stacked on one segment 372 of multiple segments on a tool 106, as illustrated in FIG. 3D. In another example, the segmented weights 210 may be stacked on all segments 382 of a tool 106, as illustrated in FIG. 3E. In yet another example, the segmented weights 210 may be stacked on opposite sides of one or more segments 392 of a tool 106, as illustrated in FIG. 3F. The segmented weights 210 may be provided in symmetrical or asymmetrical associations with the tool 106. In a further example, the tool 106 may have 2 full racks of segmented weights 210 on each segment, as illustrated in FIG. 3F.

Any combination of the segmented weights 210 can be installed at any location on the tool 106 and may not overload the tool 106, at least because of physical part restrictions of the tool 106. Such weights may be tolerated by the tool 106 for the lateral CG measurements herein. In at least one example, the hoisting sub-system 368 herein may be secured to at least a top end feature of the tool 106 or to the counterweights 122, if provided, for safety purposes. Therefore, there may be a slight tension applied to the connecting point through the crane. As illustrated, the segmented weights 210 may force, allow, or simulate, in part, a 3-axis CG to a known location (or set of locations) defined by mass properties and can allow static load 394 for the one component. In one example, the 3 scales at the legs of the frame or stand 306 may be used for such measures with the segmented weights 210 loaded on side of one segment 372, on one side of multiple segments 382, or on both sides and in symmetry for multiple segments 392.

In one example, a frame or stand 306 may have at least three legs which are associated with three independent weight scales on a horizontal axis 126A, which is along a terrestrial surface. The three independent weight scales may be used to measure weights in support of a 3-axis CG or a measurement of a static load associated with the one component of the launch vehicle. The weights may be used to calculate moments, based in part on the distance provided by the multiple segments of the tool 106. The component of the launch vehicle can be associated with the tool 106 and with segmented weights 210 on the tool during such measurements. A system having the tool 106 may include the tool 106 resting on the frame or stand 306, with the tool 106 a longest dimension 110A of the tool 106 aligned to a vertical axis 126B, which is perpendicular to the terrestrial surface to allow the measured weights. One or more of the segmented weights 210 or the counterweights 122 are adjustable by being removably installed to the tool using, in part, one or more bolt-on or quick release fasteners.

One or more of FIGS. 1 to 3F illustrate a tool 106, which can be associated with one component (such as an FA 110) of a launch vehicle 104, where the component may be associated with an encapsulated payload. The tool 106 may be adapted to be hoisted or weighed with the component in a stabilized position, such as illustrated in at least FIG. 3C or in FIGS. 3D-3F. This stabilized position may be based at least in part on one or more counterweights 122 or segmented weights 210 provided on the tool 106. The stabilized position can allow at least one operation to be performed on the component attached to the tool 106.

The at least one operation may include an operation of preparing an adapter base 108 for a component of the launch vehicle or as a weather barrier. The operation for the weather barrier may eliminate a full fairing or payload requirement for testing and hot-fire activities when the payload module or the component of the launch vehicle is part of a launch vehicle. At least one operation may include an operation of a measurement associated with a first CG measurement for the tool 106 with the component associated therewith. At least one operation may include an operation of measurement associated with a second CG measurement for the tool 106 in the absence of (or independent of) the component from the tool 106. At least one operation may include an operation of determination of a CG for the component based in part on the first CG measurement and the second CG measurement. At least one operation may include an operation of simulation of changes to a 3-axis CG or to support measurement of a static load associated with the component of the launch vehicle, as described in connection with one or more of FIGS. 3D-3E herein.

The tool 106 may include one or more tow hitches to receive the segmented weights, as described in connection with at least FIG. 2A herein. The segmented weights 210 on the tool 106 can simulate changes to a 3-axis CG or to support measurement of a static load associated with one component of the launch vehicle, as described in connection with one or more of FIGS. 3D-3E herein. The tool 106 may include at least two of the end features 124 (on its either ends) to allow the tool 106 to be reversibly used with the component and to allow the tool 106 to include at least two segments 106A, 106B which may be individually associated together at respective first end features. Then, respective second end features, which are different than the first end features (such as, each being opposite to a respective first end feature of the at least two segments), may be used to associate the segments 106A, 106B to the component on one side and to the counterweights 122 on an opposite side of the tool 106.

The tool 106 may be such that at least two hoisting features or hoists 302 may be provided for association between the tool 106 and a hoisting sub-system 368 having individual ones of the load cell scales 362 to measure weights associated with the component and with the tool 106. These measured weights may be in support of a determination of a CG measurement associated with one or more of the one component or the tool 106. This is at least because the measurement may be performed with and without the one component associated to the tool 106. The tool 106 may include support features or provisions 216 for one or more bolt-on or quick release fasteners 218, which is illustrated as provided through the support features or provisions 216 illustrated. The support features or provisions 216 may allow the counterweights 122 or segmented weights 210 to be removably installed to the tool 106. In at least the end features 124, the support features or provisions 216 may utilize the same ones of the coupling features 120 used for the adapter base 108 or used for associating together two segments 106A, 106B.

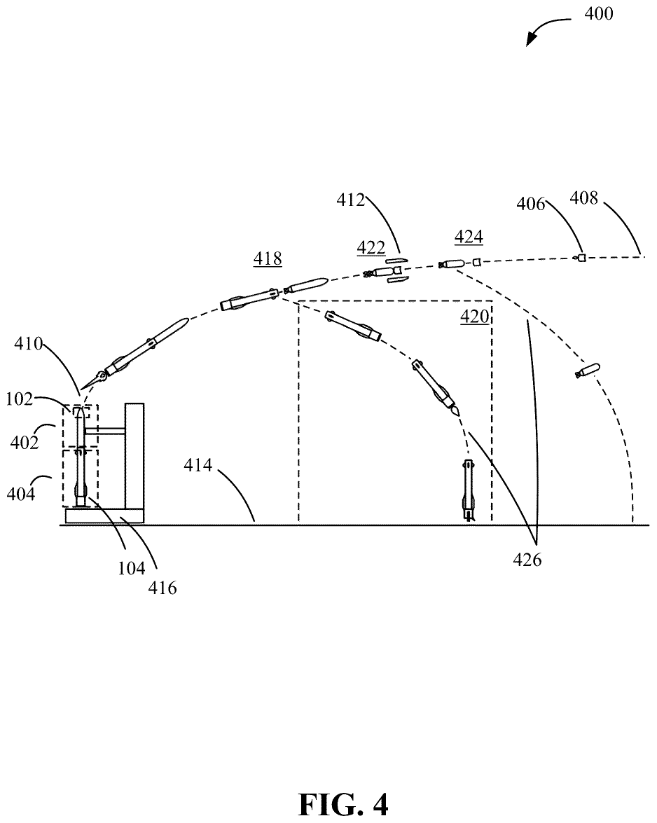

FIG. 4 illustrates an example space mission 400 having components capable of CG changes and which benefit from CG measurement or a three-axis CG or measurement of a static load, in accordance with a further non-limiting aspect of the present disclosure. A launch vehicle 104 may include at least the upper stage 402 with the payload module 102 (and the upper stage propulsion module 114 in FIG. 1), which may be on top of a lower stage (or first stage) propulsion module 404. The payload module 102 may be a component or may include a component which may be an encapsulated payload. In one example, a component may be an encapsulated payload, such as a payload 406. An encapsulated payload may be inherently unstable and may be a difficult-to-measure black-box or may consist of other unknown loads. The space mission 400 may be for placement or guidance of payload 406 to a suitable orbit 408. In one example, there may be multiple payloads for different intended orbits.

The launch vehicle may travel through an initial trajectory or flight path 410 for a period of time. The payload module 102 having the one or more payload 406 may include fairings 412 to enclose the payload 406. The fairings 412 may have sections which may be subject to separation to allow release of the one or more payload 406. In one example, a payload module 102 or the payload 406 may be one which, without limitations, docks with a space station or performs space-CLEAN related investigations, prior to re-entry and landing back on Earth's surface 414 or without returning back to the Earth's surface 414, as part of the space mission 400.

There may be maneuvers associated with components of the launch vehicle 104. A CG of a component of the launch vehicle 104 may shift or change during the space mission 400. To address the shifts in CG, in one example, pre-flight activities may be performed. The pre-flight activities may include determination of pre-launch CG measurements in the X-axis, a three-axis CG, and a measurement of a static load. These pre-flight activities may be performed before and/or when the launch vehicle is prepared on a launchpad 416. A payload 406 may include satellites and other components. Such satellites or other components may be loaded into dispensers or other deployment aspects of the payload module 102.

The space mission 400 may include a liftoff of the payload module 102 from the launchpad 416. After liftoff and after an initial time span, the launch vehicle may proceed in the initial trajectory or flight path 410 as part of an ascent phase. After ascending for a time span, a first stage separation 418 may occur. In the first stage separation 418, a payload module 102 may separate from a lower stage propulsion module 404. After the first stage separation 418, the lower stage propulsion module 404, which may proceed along a different trajectory or flight path and may perform a reorientation maneuver, followed by a landing burn, and a landing, which are all generally represented by a block 420 representation in FIG. 4.

A fairing jettison phase 422 may occur at a time which may be just prior to, during, or just after the first stage separation 418. While the fairing jettison phase 422 may occur with respect to the lower stage propulsion module 404, any dispenser associated with the lower stage propulsion module 404 may also be caused to eject any component for telemetry at this phase or between this phase and the prior first stage separation phase 418. Such a component may include an analog to digital converter (ADC) and other components. This may be so that the ADC and the other components may have a same or similar speed and trajectory (e.g., velocity) as lower stage propulsion module 404 and may be a parallel trajectory relative to the illustrated trajectory of the lower stage propulsion module 404.

The payload 406 may separate from the payload module 102 in a payload or second separation stage 424. The payload 406 may proceed in micro-gravity (also referred to by the approximation “zero-gravity”). For certain trajectories, there may be more time required to reach a suitable orbit 408 to continue docking with a space station or performing other space-related investigations and prior to any potential re-entry. The space mission 400 may end when payload 406 is set in orbit or returns to the Earth's surface 414 at a suitable time. A payload module 102 may carry equipment to and from space, samples to space, samples from space, or may be a crew module for crew or passengers.

To address CG shifts and the different payload, measurements may be required to determine an as-built weight and the CG in 3-axis for at least one component of the launch vehicle 104. For instance, the first and the second CG measurements for at least one component of the launch vehicle 104 may be performed in a horizontal position (X-plane or axis) while hoisted, as detailed in connection with at least FIGS. 3A-3C herein. The component of the launch vehicle 104 may also be subject to CG measurements in YZ-plane or axis, while standing in a vertical position or along a vertical axis which is perpendicular to a terrestrial surface, as detailed in connection with at least FIGS. 3D-3F herein.

The CG measurements taken for one or more components may be used to determine a combined mass CG and to determine shifts in the CG of at least one component of a launch vehicle that may occur during flight. The combined mass CG and the shifts in CG, as predetermined using the tool 106 herein, may account for a CG of each component of the launch vehicle 104 in different orientations to address different trajectories or flight paths 410, 426 available to components during launch, during different stage separations, and for any reorientation or return to the Earth's surface. The CG measurements obtained using the tool 106 may be used to develop the trajectory or flight path 410, 426 in one example. The CG measurements may be used to develop guidance-navigation-control inputs and/or outputs, in another example. The CG measurements may be used for studying sequential changes in CG through a space mission 400 and to ensure controllability of the launch vehicle 104.

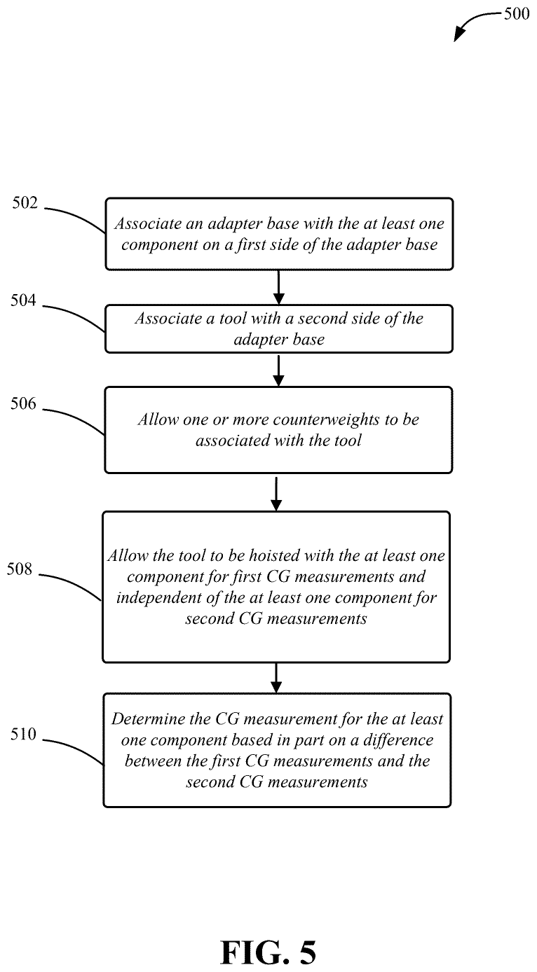

FIG. 5 illustrates a method 500 associated with a system used for a CG measurement for at least one component of a launch vehicle, according to at least one example. The method 500 may include a step to associate 502 an adapter base with at least one component on a first side of the adapter base. A determination or verification may be performed for segments and counterweights estimated for one component of the launch vehicle subject to the CG measurement herein. The method 500 may include a step to associate 504 a tool with a second side of the adapter base. The method 500 may include a step to allow 506 one or more counterweights to be associated with the tool.

The method 500 may include a step to allow 508 the tool to be hoisted with at least one component for the first CG measurements and independent of the at least one component for the second CG measurements. This step may include recording measured weights with the component when hoisted with the tool and then recording measured weights with the component removed from the tool so that the tool is weighed independently of the component of the launch vehicle. The method 500 may include waiting until a stable hoist is achieved. Although it is possible to make adjustments within the hoist in step 508, the method 500 may include verifying that a stable hoist is achieved. The method 500 may include a step to determine 510 the CG measurement for the at least one component based in part on a difference between the first CG measurements and the second CG measurements.

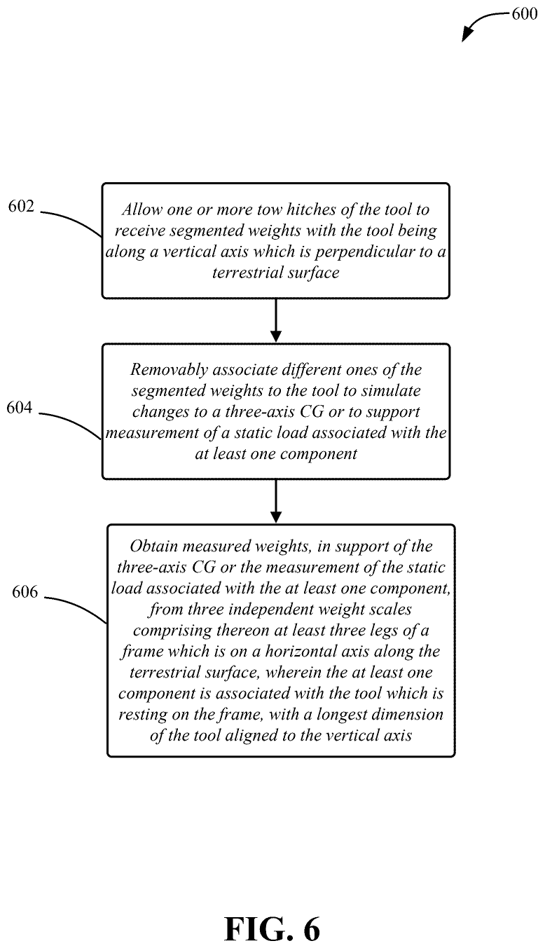

FIG. 6 illustrates a further method 600 associated with a system used for a CG measurement for one component of a launch vehicle, according to at least one example. The method 600 in FIG. 6 may be used with or separately from the method 500 in FIG. 5. For example, the method 600 in FIG. 6 may be used to simulate changes to a 3-axis CG or to support measurement of a static load associated with the one component of the launch vehicle. The method 600 in FIG. 6 may include a step to allow 602 one or more tow hitches of the tool to receive segmented weights with the tool being along a vertical axis which is perpendicular to a terrestrial surface. The method 600 may include a step to removably associate 604 different ones of the segmented weights to the tool to simulate changes to a three-axis CG or to support measurement of a static load associated with at least one component. A verification or determination may be made that the component is loaded on scale, as part of this step. The scale may be under a frame or a stand having the tool in a vertical position. In one example, the tool in the vertical position may need to be moved to a scale. In another example, it is also possible to have the tool in the vertical position on a scale prior to adding or removing segmented weights.

The method 600 includes a step to obtain 606 measured weights, in support of the three-axis CG or the measurement of the static load associated with at least one component. The measurement weights may be from three independent weight scales having thereon at least three legs of a frame which is on a horizontal axis along the terrestrial surface. In this step, at least one component may be associated with the tool, which is resting on the frame, with a longest dimension of the tool aligned to the vertical axis.

The methods 500, 600 may include removably associating the adapter base to a fixed adapter of a payload module. The fixed adapter may form at least one component, in one example. The adapter base may be coupled to the fixed adapter in place of a beanie cap, for example. The methods 500, 600 may include a step to provide, using the adapter base, a weather barrier or eliminating a full fairing or payload requirement for testing and hot-fire activities when at least one component is part of a launch vehicle.

The methods 500, 600 may include a step to associate the adapter base and the tool with at least one component and with the one or more counterweights. This may be performed with the tool being along a vertical axis which is perpendicular to a terrestrial surface. The methods 500, 600 may include a step to rotate, in part by being hoisted, the adapter base and the tool to be in a substantially parallel position with respect to a horizontal axis which is along the terrestrial surface. The first CG measurement and the second CG measurement may be determined based in part on the substantially parallel position of the adapter base and the tool. The methods 500, 600 may be such that the one or more counterweights are adjustable by being removably installed on the tool using, in part, one or more bolt-on or quick release fasteners. The methods 500, 600 may be such that at least one component comprises, encloses, or is associated with an encapsulated payload of unknown dimensions, unknown weight, and unknown CG measurements.

The present disclosure has been described with reference to various exemplary and illustrative aspects. The aspects described herein are understood as providing illustrative features of varying detail of various aspects of the disclosed disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed disclosure. Accordingly, it will be recognized by persons having ordinary skill in the art that various substitutions, modifications or combinations of any of the exemplary aspects may be made without departing from the scope of the disclosure. In addition, persons skilled in the art will recognize or be able to ascertain using no more than routine experimentation, many equivalents to the various aspects of the disclosure described herein upon review of this specification. Thus, the disclosure is not limited by the description of the various aspects, but rather by the claims.

What is claimed is:

1. A system used for a center of gravity (CG) measurement, the system comprising:
an adapter base comprising a first side and a second side, the first side to associate with at least one component of a launch vehicle; and
a tool associated with the second side of the adapter base and to be associated with one or more counterweights, wherein the tool is adapted to be hoisted with the component for first CG measurements and is adapted to be hoisted independent of the component for second CG measurements, and wherein a CG measurement for the at least one component is based in part on a difference between the first CG measurements and the second CG measurements.

2. The system of claim 1, further comprising:
one or more tow hitches of the tool to receive segmented weights along a vertical axis which is perpendicular to a terrestrial surface, the segmented weights on the tool to simulate changes to a three-axis CG or to support measurement of a static load associated with the at least one component.

3. The system of claim 1, wherein a fixed adapter forms the at least one component of the launch vehicle.

4. The system of claim 1, further comprising:
at least two hoisting features of the tool; and
a hoisting sub-system with load cell scales to measure weights associated with the at least one component and with the tool, wherein the measured weights are used to determine the first CG measurements and the second CG measurements.

5. The system of claim 1, further comprising:
a frame comprising at least three legs which are associated with three independent weight scales on a horizontal axis which is along a terrestrial surface, wherein the three independent weight scales are to measure weights in support of a three-axis CG or a measurement of a static load associated with the at least one component, wherein the at least one component is associated with the tool and with segmented weights on the tool, and a wherein the at least one component is to be resting on the frame and is to be aligned to a vertical axis which is perpendicular to the terrestrial surface to allow the measured weights in support of the three-axis CG or the measurement of the static load associated with the at least one component.

6. The system of claim 1, wherein the adapter base and the tool are adapted to be associated with the at least one component and with the one or more counterweights in a vertical axis which is perpendicular to a terrestrial surface, wherein the adapter base and the tool are adapted to be rotated, in part by being hoisted, to a substantially parallel position which is along a horizontal axis which is parallel to the terrestrial surface, and wherein the first CG measurement and the second CG measurement are determined based in part on the adapter base and the tool being in the substantially parallel position.

7. The system of claim 1, wherein the one or more counterweights are adjustable by being removably installed to the tool using, in part, one or more of bolt-on or quick release fasteners.

8. The system of claim 1, wherein the at least one component comprises, encloses, or is associated with an encapsulated payload of unknown dimensions, unknown weight, and unknown CG measurements.

9. A tool to be associated with at least one component of a launch vehicle, the tool adapted to comprise one or more counterweights or segmented weights thereon and adapted to be hoisted or weighed in a stabilized position with the at least one component and with the one or more counterweights or segmented weights attached thereon, wherein the stabilized position is to allow at least one operation to be performed on the at least one component of the launch vehicle.

10. The tool of claim 9, wherein the at least one operation comprises one or more of:
preparation of an adapter base as a weather barrier or to eliminate a full fairing or payload requirement for testing and hot-fire activities associated with the at least one component, when the at least one component is a fixed adapter which is attached to the adapter base;
measurement associated with a first center of gravity (CG) measurement for the tool with the at least one component associated therewith;
measurement associated with a second CG measurement for the tool in the absence of the at least one component from the tool;
determination of a CG for the at least one component based in part on the first CG measurement and the second CG measurement; or
simulation of changes to a three-axis CG or to support measurement of a static load associated with the at least one component.

11. The tool of claim 9, further comprising:
one or more tow hitches to receive the segmented weights, the segmented weights on the tool to simulate changes to a three-axis CG or to support measurement of a static load associated with the at least one component.

12. The tool of claim 9, further comprising:
a plurality of end features to allow the tool to be reversibly used with the at least one component and to allow the tool to comprise at least two segments which are individually associated together at respective first end features and wherein respective second end features of the at least two segments form the plurality of end features of the tool.

13. The tool of claim 9, further comprising:
at least two hoisting features to be associated with a hoisting sub-system having load cell scales to measure weights associated with the at least one component and with the tool, in support of a determination of a CG measurement associated with one or more of the at least one component or the tool.

14. The tool of claim 9, further comprising:
support features for one or more of bolt-on or quick release fasteners, the support features to allow the one or more counterweights or segmented weights to be removably installed on the tool.

15. A method for a center of gravity (CG) measurement for at least one component of a launch vehicle, the method comprising:
associating an adapter base with the at least one component on a first side of the adapter base;
associating a tool with a second side of the adapter base;
allowing one or more counterweights to be associated with the tool;
allowing the tool to be hoisted with the at least one component for first CG measurements and independent of the at least one component for second CG measurements; and
determining the CG measurement for the at least one component based in part on a difference between the first CG measurements and the second CG measurements.

16. The method of claim 15, further comprising:
allowing one or more tow hitches of the tool to receive segmented weights with the tool being along a vertical axis which is perpendicular to a terrestrial surface;
removably associating different ones of the segmented weights to the tool to simulate changes to a three-axis CG or to support measurement of a static load associated with the at least one component; and
obtaining measured weights, in support of the three-axis CG or the measurement of the static load associated with the at least one component, from three independent weight scales comprising thereon at least three legs of a frame which is on a horizontal axis along the terrestrial surface, wherein the at least one component is associated with the tool which is resting on the frame, with a longest dimension of the tool aligned to the vertical axis.

17. The method of claim 15, further comprising:
removably associating the adapter base to a fixed adapter of a payload module, the fixed adapter forming the at least one component, wherein the adapter base is to be coupled to the fixed adapter in place of a beanie cap; and
providing, using the adapter base, a weather barrier or eliminating a full fairing or payload requirement for testing and hot-fire activities when the at least one component is part of a launch vehicle.

18. The method of claim 15, further comprising:
associating the adapter base and the tool with the at least one component and with the one or more counterweights, with the tool being along a vertical axis which is perpendicular to a terrestrial surface; and
rotating, in part by being hoisted, the adapter base and the tool to be in a substantially parallel position with respect to a horizontal axis which is along the terrestrial surface, wherein the first CG measurement and the second CG measurement are determined based in part on the substantially parallel position of the adapter base and the tool.

19. The method of claim 15, wherein the one or more counterweights are adjustable by being removably installed on the tool using, in part, one or more of bolt-on or quick release fasteners.

20. The method of claim 15, wherein the at least one component comprises, encloses, or is associated with an encapsulated payload of unknown dimensions, unknown weight, and unknown CG measurements.
